(19) United States
(12) Patent Application Publication
(10) Pub. No.: US 2015/0371165 A1
(43) Pub. Date: Dec. 24, 2015

(54) SUBSCRIPTION BASED BUSINESS ANALYTICS

(71) Applicants: Mary Elser Long, Fairburn, GA (US); Daniel James Seydel, II, Shelton, WA (US)

(72) Inventors: Mary Elser Long, Fairburn, GA (US); Daniel James Seydel, II, Shelton, WA (US)

(21) Appl. No.: 14/747,587

(22) Filed: Jun. 23, 2015

Related U.S. Application Data
(60) Provisional application No. 62/015,895, filed on Jun. 23, 2014.

(51) Int. Cl. G06Q 10/06; G06F 17/30; H04L 29/08

(52) U.S. Cl. CPC G06Q 10/0637; H04L 67/02; G06F 17/30882; G06F 17/30905; G06F 17/30896

(57) ABSTRACT

A subscription based business analytics system and process that collects and analyzes a member's business information across a range of categories pertaining to the business; including its organization, employees, licenses, the businesses' customers; including prospects and opportunities; the business' finances; the businesses' projects; and its banking. A provider utilizes the business analytics system to service the needs of its members.

### CROSS-REFERENCE TO RELATED APPLICATION

This application claims the benefit of priority of U.S. provisional application No. 62/015,895, filed Jun. 23, 2015, the contents of which are herein incorporated by reference.

### BACKGROUND OF THE INVENTION

The present invention relates to businesses and, more particularly, to systems and methods for assisting small business owners with planning, managing, analyzing, and administering their businesses. Currently, smaller businesses cannot afford to purchase or develop software to help them with their business administration, business growth opportunities, or reconciling information across all aspects of their businesses. Smaller businesses generally keep manual systems because of the high costs associated with obtaining automated systems. What automation systems they may use are limited in scope, such as payroll, orders processing. Moreover, these systems do not integrate or provide information from these systems across the entire business.

As can be seen, there is a need for a system and method for a business analytics system that allows a businesses to subscribe to a cloud database for administration and data repository.

### SUMMARY OF THE INVENTION

In one aspect of the present invention, a method of a provider serving web pages offering business analytics to a member, the method comprises: (a) serving, from a server available to the provider, a web page on a member's web browser, wherein the web page presents a plurality of member selectable menu items, the menu items corresponding to a plurality of predetermined categories of business information; (b) receiving, at the server, a member's selection of a menu item; (c) automatically with the server computer-generating and transmitting to the web browser a second web page that includes: (1) information pertaining to the selected category of business information; (2) a plurality of data entry fields, corresponding to the selected category of business information, wherein each data entry field, corresponds to a data element; (3) a link, responsive to a member selection in the web browser; (d) receiving, in response to a member's selection of the link, data elements entered into the data entry field by the user; (e) storing, in a database available to the provider, the received data elements; (f) analyzing, the database data elements; and (g) providing an actionable recommendation to the member based on the analysis of the data elements.

In another aspect of the present invention a computer-readable memory adapted for use by a provider in serving web pages offering business analytics to its members, the computer-readable memory is used to direct a computer available to the provider to perform the steps of: (a) serving, from a server available to the provider, a web page on a member's web browser, wherein the web page presents a plurality of member selectable menu items, the menu items corresponding to a plurality of predetermined categories of business information; (b) receiving, at the server, a member's selection of a menu item; (c) automatically with the server computer-generating and transmitting to the web browser a second web page that includes: (1) information pertaining to the selected category of business information; (2) a plurality of data entry fields, corresponding to the selected category of business information, wherein each data entry field, corresponds to a data element; (3) a link, responsive to a member selection in the web browser; (d) receiving, in response to a member's selection of the link, data elements entered into the data entry field by the user; (e) storing, in a database available to the provider, the received data elements; (f) analyzing, the database data elements; and (g) providing an actionable recommendation to the member based on the analysis of the data elements.

In yet another aspect of the invention, there is a system useful in a provider serving web pages offering business analytics, the system includes: a computer storage containing data, for each of a plurality of web pages; a computer server available to the provider, which is coupled to the computer storage and programmed to: (1) serve, from a server available to the provider, a web page on a member's web browser, wherein the web page presents a plurality of member selectable menu items, the menu items corresponding to a plurality of predetermined categories of business information; (2) receive, at the server, a member's selection of a menu item; (3) automatically with the server computer-generating and transmitting to the web browser a second web page that includes: (i) information pertaining to the selected category of business information; (ii) a plurality of data entry fields, corresponding to the selected category of business information, wherein each data entry field, corresponds to a data element; (iii) a link, responsive to a member selection in the web browser; (4) receiving, in response to a member's selection of the link, data elements entered into the data entry field by the user; (5) storing, in a database available to the provider, the received data elements; (6) analyzing, the database data elements; and (7) providing an actionable recommendation to the member based on the analysis of the data elements.

These and other features, aspects and advantages of the present invention will become better understood with reference to the following drawings, description and claims.

### BRIEF DESCRIPTION OF THE DRAWINGS

FIG. 1 is a flow chart of the method of the invention.

FIG. 2 is an exemplary home page screen of an embodiment of a website.

FIG. 3 is a partial screen shot of an exemplary presentation layer of an About Me module.

FIG. 4 is a partial screen shot of an exemplary presentation layer for a Company module and Basic Information sub-module.

FIG. 5 is a partial screen shot of an exemplary presentation layer for a Company module and More About Company sub-module.

FIG. 6 is a partial screen shot of an exemplary presentation layer for a Customers module.

FIG. 7 is a partial screen shot of an exemplary presentation layer for a Finance module.

FIG. 8 is a partial screen shot of an exemplary presentation layer for a Projects module.

FIG. 9 is a partial screen shot of an exemplary presentation layer for a Banking module.

FIG. 10 is a partial screen shot of an exemplary presentation layer for an Experience module.

FIG. 11 is a representative data model for a Company database.

FIG. 12 is a representative data model for a Customer database.

FIG. 13 is a representative data model for a Finance database.

FIG. 14 is a representative data model for a Projects database.

FIG. 15 is a representative data model for a Banking database.

FIG. 16 is a representative data model for an Experience database.

FIG. 17 is a representative flow chart for executing a procedure call.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a subscription based business analytics system that collects and analyzes business information across a range of categories pertaining to the business; including its organization, employees, licenses, the businesses' customers; including prospects and opportunities; the business' finances; the businesses' projects; and its banking. The business analytics system comprises: a computer having a user interface; and a program product comprising machine-readable program code for causing, when executed, the computer to perform the following process steps: producing an electronic representation of at least one report for a specific business; producing an electronic representation of at least one legal business document for the specific business; producing a plurality of statistics for providing project estimates for the specific business; and producing a plurality of future sales prospects for the specific business. In an embodiment, a provider utilizes the business analytics system to service the needs of its members, who access the system on a subscription basis.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The front end of the system may preferably developed and implemented utilizing the ASP.NET web development framework by Microsoft Corporation. ASP.NET is a web framework for building Web sites and Web applications using HTML, CSS and JavaScript. ASP.NET may be utilized for building standards-based websites with HTML5, CSS3, and JavaScript. ASP.NET supports three approaches for making web sites. ASP.NET Web Forms uses controls and an event-model for component-based development. ASP.NET MVC values separation of concerns and enables easier test-driven development. ASP.NET Web Pages prefers a single page model that mixes code and HTML markup. Utilization of the ASP.NET framework is described on the Microsoft Developer Network, at https://msdn.microsoft.com/en-us/library/aa155073.aspx, and is expressly incorporated herein by reference in its entirety.

The back end of the system is preferably implemented utilizing Microsoft Azure and Azure SQL Database. Microsoft Azure is a cloud computing platform and infrastructure, created by Microsoft Corporation, for building, deploying and managing applications and services through a global network of Microsoft-managed datacenters. Azure provides both PaaS (platform as a service) and IaaS, (infrastructure as a service) and SaaS (Software as a service) services and supports many different programming languages, tools and frameworks, including both Microsoft-specific and third-party software and systems. This invention is utilizing the SaaS feature of Azure using its subscription service. Azure is described on the Microsoft Azure Documentation Center, located at http://azure.microsoft.com/en-us/documentation/, and is expressly incorporated herein by reference in its entirety. Alternative platforms for implementing the invention include systems, such as, Amazon's AWS (Amazon Web Service), and Google's Cloud Platform family of systems.

### Member

A member accesses the system by signing up and applying for a subscription to the system. As part of the application process, the member is provided and receives a Member Identification, that uniquely identifies a member within the system. The member also receives a member login for accessing the system. A member may also be assigned a member type, that may for example indicate the system services that the member has elected to receive or participate in. Member type may be indicated as basic, advanced, or premium, or the like, indicating a subscription or subscription package offered through the system. The member may also receive a Member Title, indicating perhaps the name of the business or a moniker selected based on the personal preferences of the member during the application process.

The present system may include a system that gathers data input by a user, edits and places the data into appropriate tables of the database residing in a cloud. In certain embodiments, the database may be placed on site. The user may access this data along with other functions by subscribing to a service and becoming a member. All data may be stored with a member identification and reported by that same member identification. There may be various tiers of membership that may afford additional services through their membership. The user may subscribe to the system for access to the functions of the system.

The membership portal may be operated as part of the system or may alternatively be provided through a third party provider of such services to receive memberships and payment processing and verification for the user's payment processes. The membership portal may provide these services for the application at a subscription rate per user with the price tiered by number of users.

### Web Portal

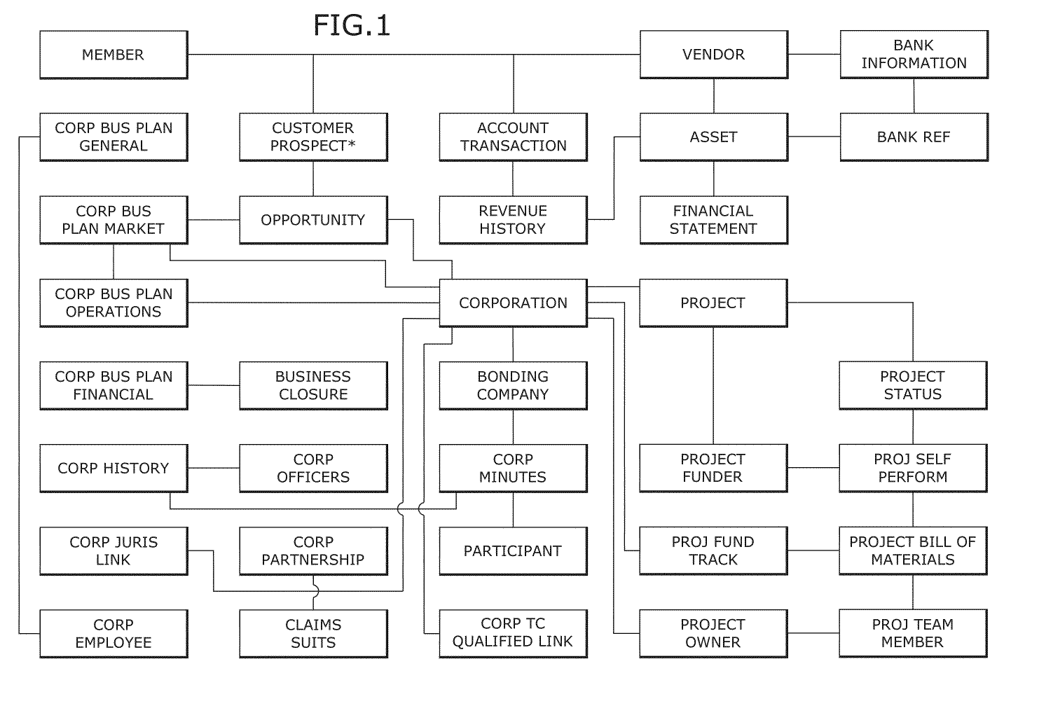

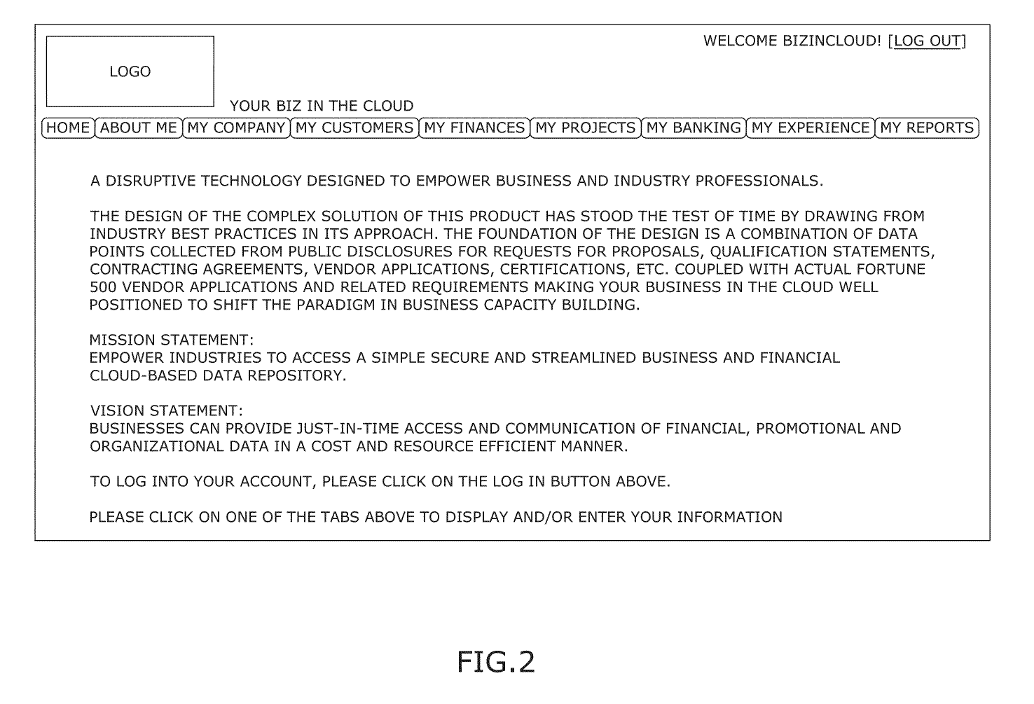

The member accesses the business analytics system, preferably via a web portal, such as shown in reference to FIGS. 2-10. As previously indicated, the web portal may be implemented, for example by the ASP.NET architecture provided my Microsoft Corporation. An exemplary “home” page is depicted in FIG. 1, indicating a typical menu selection, that may be available to a subscribing member, for example, based on their membership level. The space provided for the logo may be that of the subscription service, or alternatively, once a member has logged into their account, it may be populated by a logo belonging to the member's particular business, or business unit.

### About Me

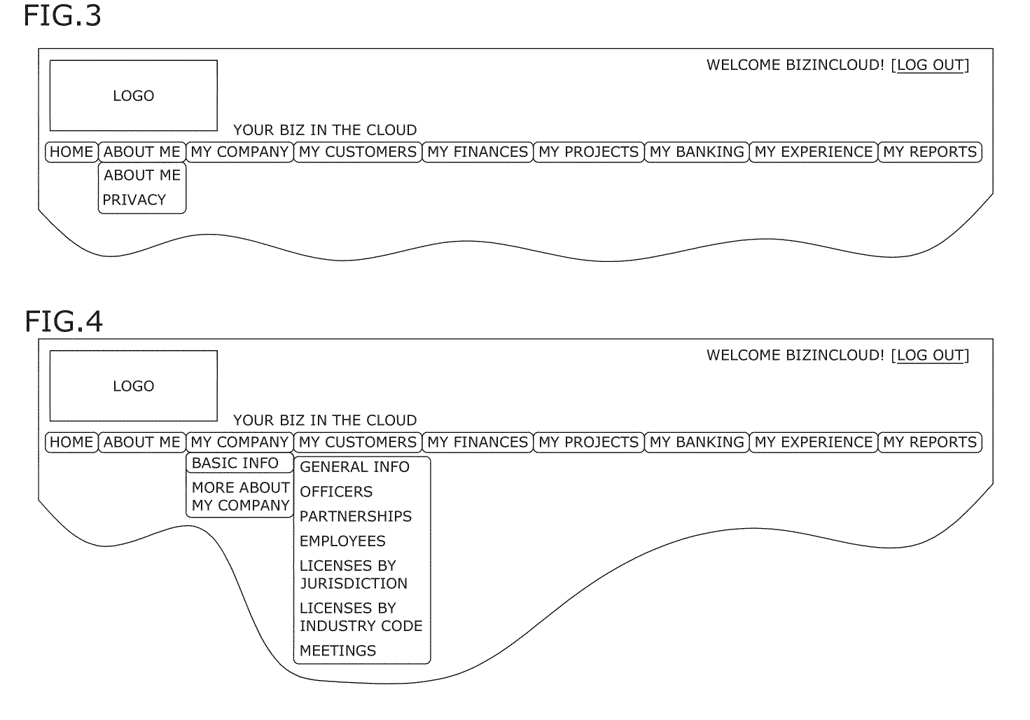

Referring to FIG. 3, the “About Me” menu selection provides the member the ability to access a page containing demographic information for the owner or the owner's business or businesses. The page allows for the initial entry of demographic information pertaining to the business and also allows the user to update the information pertaining to the business over time in order to capture changes as they occur. Demographic information that may be input in a data entry field and displayed on the page may include, the owner's title, last name, first name, ethnicity, gender. The demographic information may further include the owner's physical address, mailing address, e-mail address, and phone numbers. Additional editable data elements may include URL's for the owner's/business' internet home page, and alternatively links to the owner's pages on social media networks, such as Linkedin, FaceBook, and Twitter, for example. As will be understood throughout the system described herein, through the member's interaction with the user interface, data elements input by the member are exchanged between the front end ASP.NET and an SQL database maintained and operated within the back end of the Azure cloud based services.

The privacy menu selection will provide the user access to a privacy policy for the business analytics system.

### Company

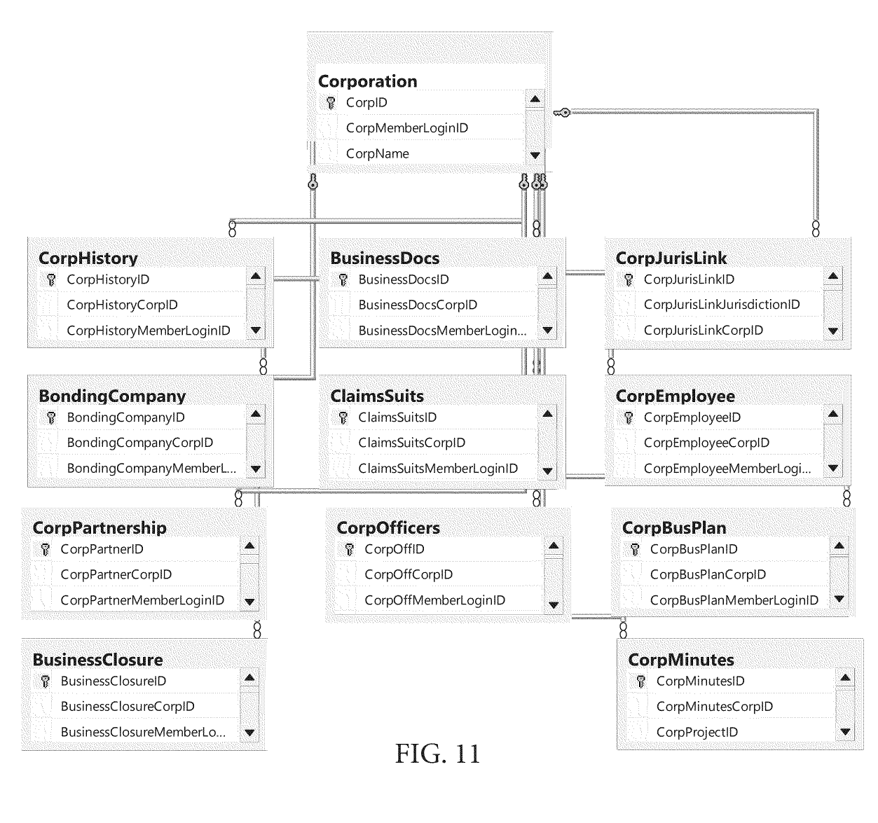

In reference to FIG. 4, a menu selection may be provided for “My Company,” or Company module. Upon accessing the Company page, the user is provided an editable form for information pertaining to a business, such as: the business name, type of business (based on its legal structure of the business entity in the jurisdiction where it is formed), a phone number, tax identification numbers, address information. A representative data model for company information within an Azure SQL DB is shown in reference to FIG. 11. The user is also prompted to identify any legal matters pertaining to the business; such as the pendency of any law suits against the company or whether the company has filed any suits on its own behalf. The user may also be prompted for the existence of or status of a current financial statement for the business.

The Company menu may also include an Officer's selection, which provides an editable listing of officers for the business entity, providing a visual indication of an officer's start date, last name and first name. A selection is provided to add and/or edit an officer, which allows the specification of data for an officer, including an officer type, which permits an identification of the duty position of the officer within the organization, a start date, an end date, the officer's name, address, and contact information such as e-mail and telephone numbers.

A Partnerships menu selection allows entry of information pertaining to any partnerships associated with the business entity, including the identification a partner's name of a partner type, origination date.

Also within the Company menu tree is an Employees menu item. Selection of the Employee menu item provides an editable listing of current employees of the company, including basic employee demographic information, such as, name, and job role. Employee information may be updated via an edit selection associated with a particular employee or an Add New Employee button. Information that may be entered and retained within the system pertaining to an employee may include the employee's name, address, social security number, contact information, employee role, hire date, termination date, education level. Preferably, the employee data entry screen may also include a description of the employee's activities for the organization, and an assessment of the employee's results achieved for the organization.

The Company menu tree may also include a Licenses by Jurisdiction and Licenses by Industry Code menu items. The Licenses by Jurisdiction would include information pertaining to licenses the business has acquired, for example, to operate within a particular city, county, state, or other governmental organization. The Licenses by Industry Code menu item may include information relating to licensure required or desired for operating in a particular field of endeavor, such as construction, medical, architecture, engineering, and the like. Preferably, these are presented via drop down selection items relating to the North American Industry Classification System (NAICS).

Preferably, the My Company menu selection will include a Meeting item entry which permits the user to schedule, maintain a track important meetings to the organization, and more preferably categorizing the meetings by type, such as, board meetings, project design, project acceptance, sales, marketing, and the like.

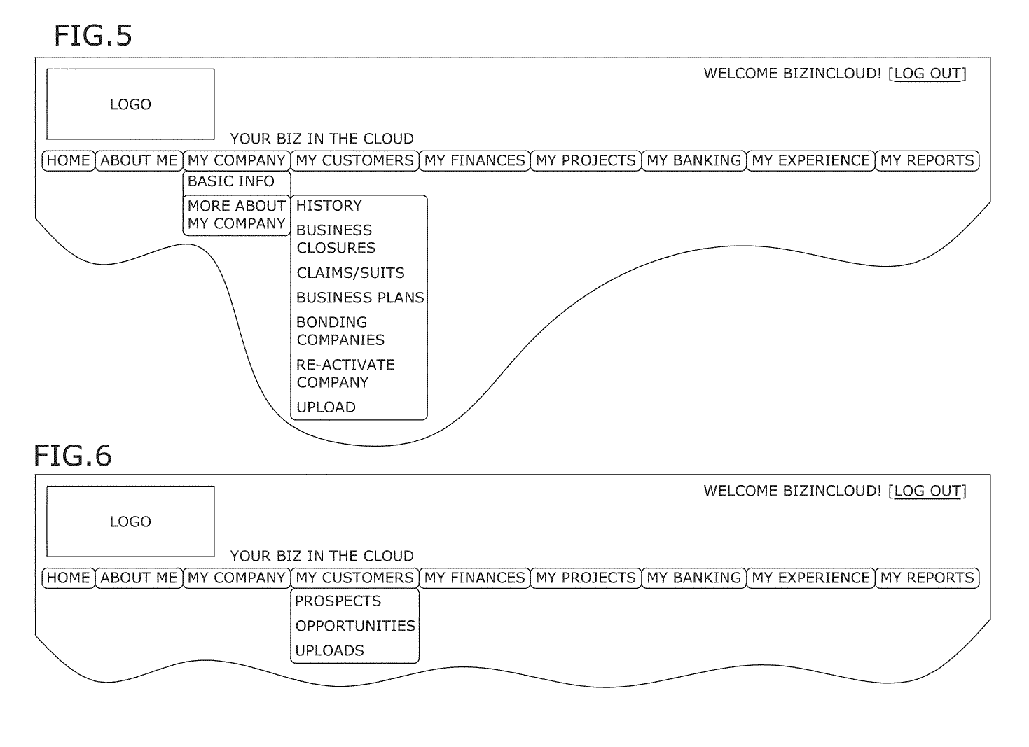

Referring now to FIG. 5, the My Company module may further contain a process for the user to input additional information pertaining to the company under a More About My Company sub-module. The sub-module may provide for the capture of information pertaining to historical information of the business, such as business closures with a description for a reason or circumstances surrounding the occurrence. Under Claims and Suits, the user can enter information concerning any claims or suits in which the company has been involved, including: a description, filing date, results, attorney and firm name, judge and a resolution date.

A Business Plans sub-module, within the My Company module, prompts and permits the user to enter information for developing and capturing a business plan for the organization, including: a table of contents, executive summary, organizational plan, financial plan, marketing plan; operations plan; research plan; and strategic plan. The My Company module, may further comprise the collection and display of information pertaining to bonding companies that may be important to the business. Information would include identification of a job limit, an aggregate job limit, start date, bonding fees, interest rates, and contact information for the bonding company.

Preferably, the My Company module may further include a document upload sub-module, which permits the user to upload computer readable copies of documents that are important to the business. The documents may be identified by a date and document name, and be provided an indication of the document type, such as organizational documents; meeting minutes; resolutions; projects; financials; etc.

### Customers

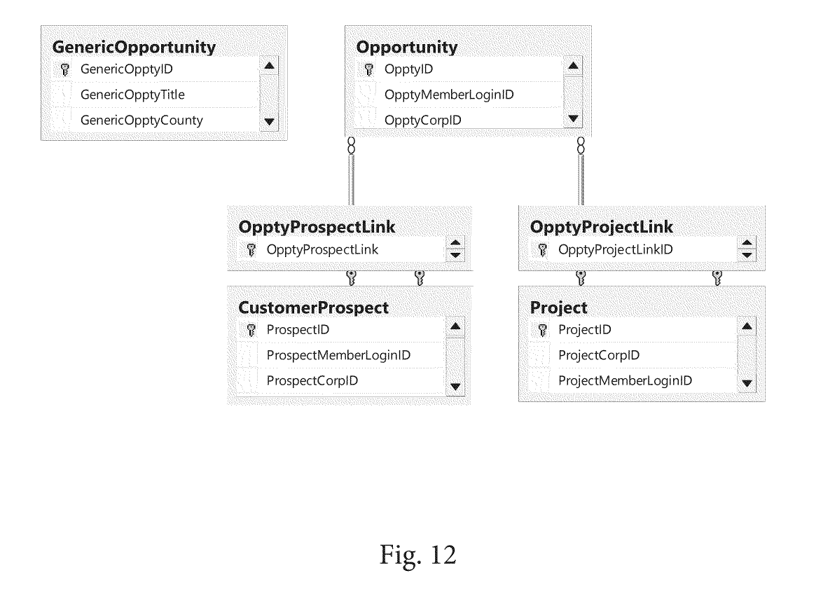

In reference to FIG. 6, the presentation layer may further include a My Customers module, which permits the user to review and input information relating to their customers. Within the Prospects area, the user may review and enter information relating to potential customer prospects, including the business or individual's name, contact information, and industry code. Also included, may be an opportunities sub module, which permits the user to review and identify relevant information pertaining to an opportunity. A representative data model for Customer information within an Azure SQL DB is shown in reference to FIG. 12. The opportunity may have a title, dollar value, relative rating of the opportunity (hot, warm, cool, and cold), industry type, description, and bid information. Values may be updated as the opportunities progress or disappear. As with the My Company module, the My Customers module also provides a user access to functionality to upload documents relating to customers.

### Finance

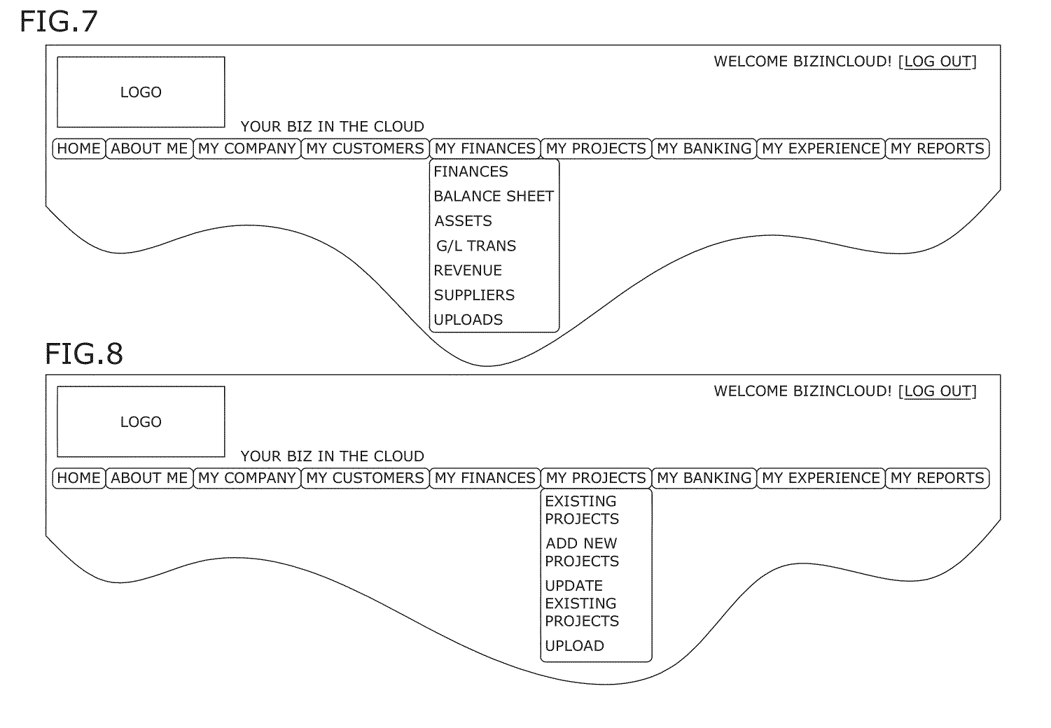

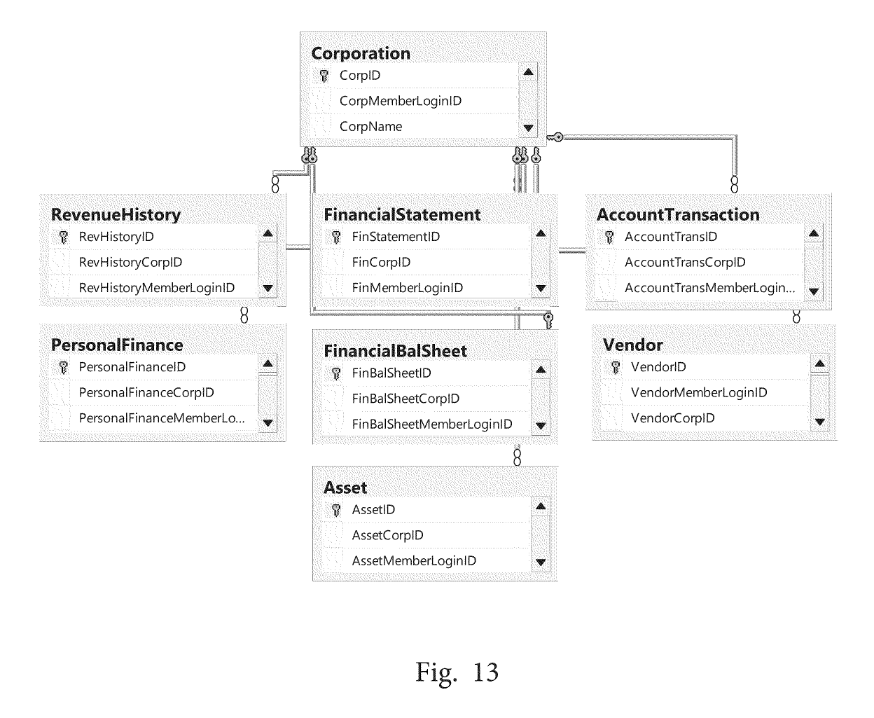

As seen in reference to FIG. 7, the system provides a My Finances module that provides for the collection, analysis, sharing, and retention of financial information that is important to the business. An initial screen in the Finances sub module provides a tabular display for financial reports generated within the system, including a report name and date. A report may be edited by selection of an edit or an add financial report button in the user interface. A Financial Information editing screen allows for the display, entry and editing of information relating to a financial report, including: a report description, date, a variety of financial elements, such as values for: cash; marketable securities; accounts receivable; inventory; average inventory; fixed assets; prepaid charges; intangibles; retained earnings; additional paid in capital; common stock; preferred stock; long term debt; current portion of long term debt; taxes payable; accrued expenses payable; notes payable; accounts payable; cost of goods sold; cost of goods credited; credit sales; sales; other expenses; depreciation expenses; selling administration expense; interest income; other income interest expenses. A representative data model for finance information within an Azure SQL DB is shown in reference to FIG. 13. The Finances sub-module also permits the identification of the preparer of the financial statement, including demographic information and responsibility in connection with the organization.

The My Finances module may also include A Financial Balance Sheet sub-module, which, through interaction with the other modules in the system, and user inputs, provides a balance sheet for the organization. The financial balance sheet may include a list of current assets pertinent to the business; current liabilities relating to the business; investments; property, plant and equipment; long term liabilities; intangible assets; stockholders” equity, and other assets.

The My Finances module may also include an Equipment sub-module, which provides a tabular listing of equipment and its purchase date. The Equipment sub-module also permits the editing of equipment information or the addition of a new equipment record. Information pertaining to equipment may include a description; present value purchase date; purchase price; loan balance; interest rate and dates relating to the foregoing.

Further in reference to FIG. 7, the Finance module may include a General Ledger Account Transactions (G/L Trans) sub-module. This sub-module, permits the receipt and entry of general ledger account transactions that may be categorized by type, attributed to a vendor (selected from a list of company vendors within a Vendor sub-module described below), a description of the transaction, a transaction amount, and allocation to a selectable G/L account.

The Finance module may further include a Revenue sub-module, which may provide a revenue history of the company, compiled annually, quarterly, or by any suitable reference time period. As previously indicated, the Finance module preferably includes a Vendor sub-module, which includes the name, and contact information for the vendor, as well as an indication of the vendor type, such as subcontractor, professional services, or supply. As with other modules, the Finance module permits a user to upload pertinent business documents for storage within the system.

### Projects

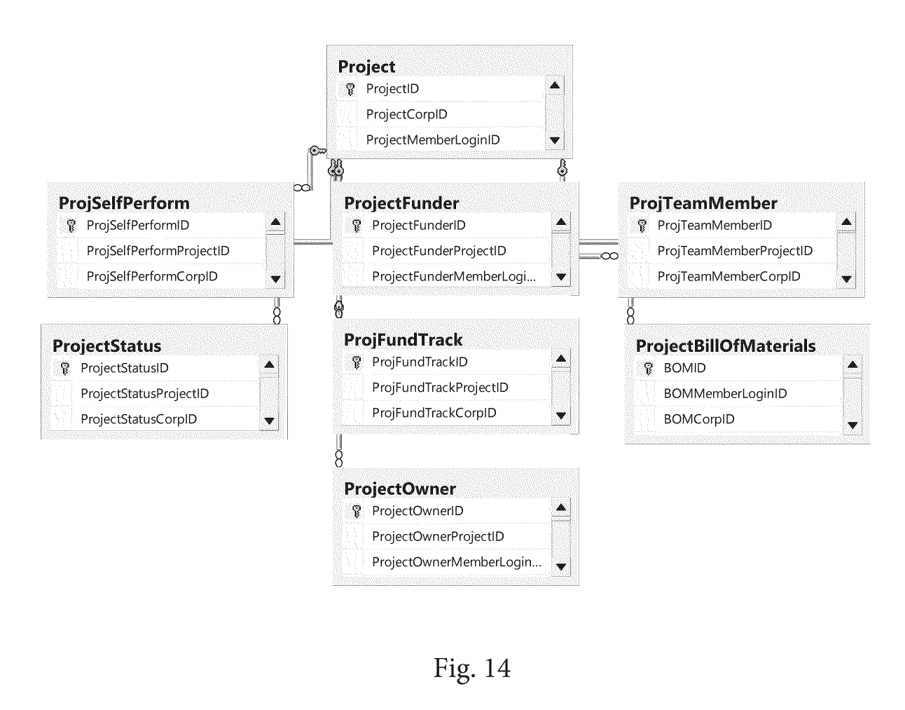

Turning now in reference to FIG. 8, the system may further comprise a Projects module that facilitates project management, as well as the tracking and allocating of resources committed to or expended by a particular project. A representative data model for Projects information within an Azure SQL DB is shown in reference to FIG. 14. Selecting the Projects menu item, may bring the user to a submenu of tasks relating to project planning, management and administration, such as: Project Information; project status; Estimated/Actual Materials Expense; Team Members; Services Performed; Project Owner′ Project Funder; and Track Funds.

The Project Information presentation layer includes a listing of a business's projects. As with other interfaces in the system, the user may add or modify project information via selection of an edit button or an add new project button. Adding or editing a project presents a project information page where the project name contract amount, percent complete; percent own forces; contract amount; project cost, narrative description of the project; and a narrative description of the scope of the project may be viewed or entered.

The Project Status Information sub-module permits a user to update an existing project′ status for projects that have already been initiated in the system. In this case, the user selects from a list of existing projects to which the status update pertains, and may select or modify the project status type. The status information also provides a project status short description and project status long description. After editing or updating an entry, the user may update or delete the project status information. The Project Status Information screen also permits to add participants or edit participants that may have a role or part to play in a particular project.

The Projects module may further comprise a Project Materials Expense (Estimated Actual) sub-module that permits the user to provide an estimated or actual expense for materials allocated to a project. The materials expense is assigned a project name, vendor, description, unit of measure, projected quantity, unit cost and total cost, as well as actual quantity unit cost, and total cost. The materials expense may be assigned an expense type, corresponding to the industry the business is associated with. Optionally, the expense may indicate whether the expense reflects a change order to the project.

The Team Members sub-module provides an opportunity to assign members to a project, selected from a list of existing project, and a list of skills or roles the team member provides to a project. The entry screen also provides demographic and contact information for the team member. As with the employee sub-module in the Business module, team members may be provided a narrative description of the team member's activities towards the project, as well as a narrative description of the team member's results in connection with the project.

The Project module may also provide for the user to identify services performed under a project. The Services Performed sub-module, provides a drop down list of existing projects for which the services may be performed. The services may further be identified by NAIC Sector, SubSector, and Industry Codes. The Services Performed sub-module may further include a project percent complete and an indication of whether the service is a service provided by a contractor or not. The Project module may also provide for a Project Owner Information page that correlates an owner's name, contact information, share of project ownership, and a project owner type of ownership, to allow project owners to be typed to a particular relevant group. For example, in the construction, the owner type could be selected from a list including: public (city, county state), private, and transportation.

A Project Funder sub-module provides the ability to identify funders correlated to a project, including demographic information, and the funding amount provided by a funder to a project. The information provided through the Project Funder sub-module may be utilized with the Project Fund Tracking Information sub module, allows tracking of the contribution of funds, the date received, and the date funds may be allocated.

### Banking

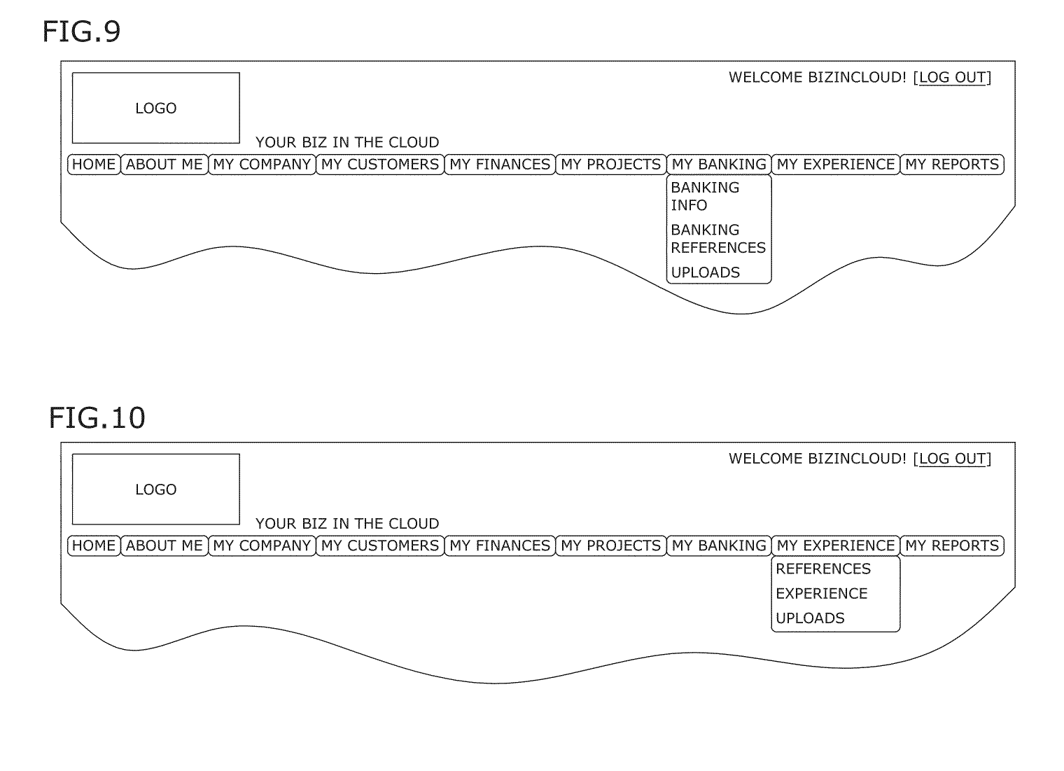

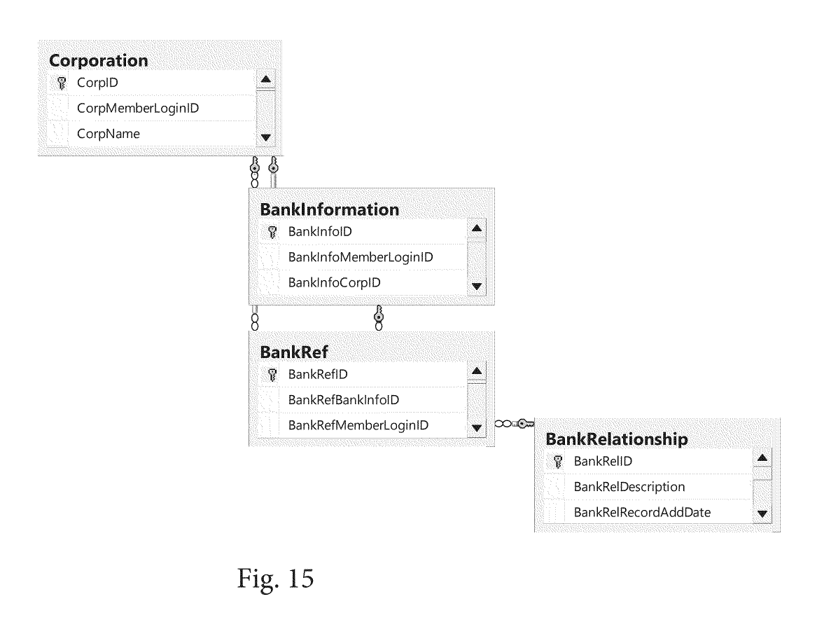

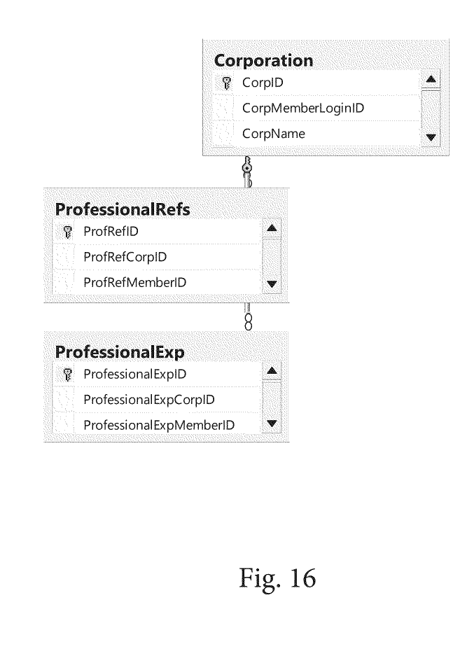

The business analytics system of the present invention, may also comprise a Banking module. As may be seen in reference to FIG. 9, the Banking module may further comprise, a Banking Information, Banking References, and Uploads, sub-modules. Within the Banking Information sub-module, information is provided pertaining to one or more banks with which the business may be associated. A representative data model for company information within an Azure SQL DB is shown in reference to FIG. 15. A Bank Reference sub-module may also be provided to the Banking module that permits the association of a bank and its reference relationship to the business. The relationship may, for example, be that of a primary bank, a loan bank, or an investment bank for the business. The bank reference information may further include a description of the reference, a loan balance, interest rate, and other information of relevance to the bank.

### Experience

In reference to FIG. 10, an Experience module, provides for the entry, display, and updating of experience relating to the business, business leadership or any other individual involved in the business as desired by the user. Within the References sub-module professional reference information pertaining to the user or business may be entered, displayed and edited. A representative data model for Experience information within an Azure SQL DB is shown in reference to FIG. 16. Professional Reference information may include the reference's name, company, title, contact information, and may further include URL links to a social media or web site for the reference.

In the Experience sub-module, the professional experience for the business owner, business leadership, and any other individual involved in the business as desired by the user may be received. The experience information may include the NAICS sector, subsector, and industry codes. A professional experience description may also be entered to capture a narrative description of the individual's experience pertaining to the selected NAICS code, along with years of experience and other pertinent information, such as start and end dates related to that experience.

The business analytics system may also include a Reports module, wherein the user may select from a number of preformatted reports, such as a Vendor report, Business Information, Project/Vendors, Basic Project, and Business Officers, and the like. As will be described, on the back end, customized reports, tailored to specific opportunities, legislative, industry specific parameters, may also be provided.

As indicated previously, in a preferred embodiment of the information received via the ASP.NET framework is incorporated into a sequel database (SQL DB) as part of a system, such as, the Azure cloud computing platform and infrastructure. When incorporated into the database, a variety of analytics can be performed on the user's business information. The more complete the user's business information is, the more the system is able to provide useable analytics, with actionable recommendations for the member. For example, the more complete the user's business information is, the system will be able to identify, access, and process public data on the internet that pertains to a designated category of the business.

### Analytics

According to a preferred embodiment of the invention, the business analytics system of the present invention utilizes the business information provided by the user, performs an analysis of that information, and makes recommendations for the business across various elements of the business' concern. Using the information provided by the user compared to statistical information available on pubic sites on the internet, the system provides a score for each of these elements and presents the information to the user. This information may be presented at the top of the presentation layer screen for the designated category of the business or may be pushed to the user via an email notification. A first analysis is done on the business information provided by the member, which is assessed on completeness, correlation of content, and perceptible inconsistencies in the information. As an additional element, the system provides an analysis of the industry or sector that pertains to the member's business, as indicated for example, by the NAICS codes. As a next element, the member's business is scored or graded on economic conditions of the user as compared to other individual businesses gathered from streaming data from public websites providing such information. As a result, the application assists with providing recommendations for solutions, training for staff, and other stakeholders. As another element, the system provides an opportunities analysis and recommendations for the business, based on the businesses capabilities and industry segment. As yet another element, the system provides analysis and recommendations for subject matter expertise and academic case studies of relevance to the business. As yet an additional element, the system can provide analysis and access to legislative policies affecting a particular industry or segment based on data that is extracted from various public sites that provide information concerning upcoming and completed legislative activities.

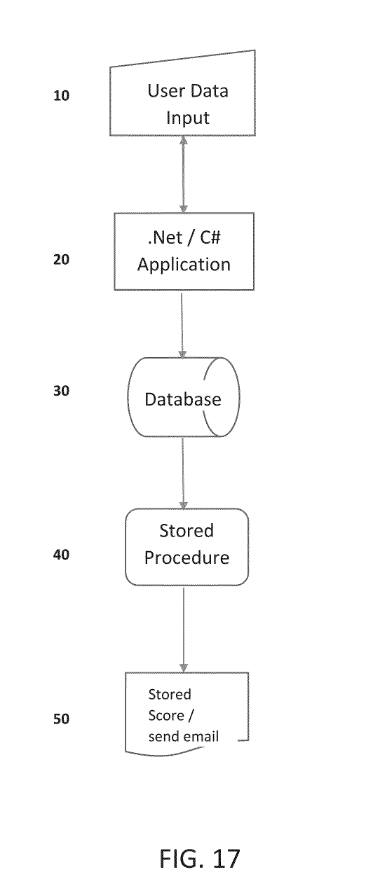

As may be seen in reference to FIG. 17, an exemplary procedure for receiving and performing analytics according to the present invention is shown. At block 10, the member enters an item of user input data, into a cell for the collection of the item of user input data that is provided through the presentation layer. At block 20, the ASP.NET application receives the input and stores the corresponding user input data in a database 30, such as an SQL database within the Azure cloud architecture. At block 40, a stored procedure call (Stored Proc) within the SQL database is triggered by an event, such as insert/or update instruction for a designated row within a database table, according to a schedule, such as a passage of a specified time since a last execution of the stored procedure, or at the request of a user. After the trigger event, the stored procedure call calculates a score for the user input data according to a predetermined algorithm. After execution of the stored procedure call, at block 50, the score is stored and/or a message, such as an e-mail is generated to notify the user of the result.

### Business Information

As indicated above, the analytics provided by the system provides a score for each of the elements and presents the information to the user. A first analysis is done on the business information provided by the member, which is assessed on completeness, correlation of content, and perceptible inconsistencies or deficiencies in the information. Based on the system's analytics, a score, based on the content of the business information, is presented to the member. In a preferred embodiment of the invention, the analytics of the members' business information may also provide recommendations for the user and regarding the advisabliity of including additional information items pertaining to the business. In this case, the recommendations may be instructional in nature, in that they provide the business owner context for the need or importance of missing or incomplete information from their business information. The recommendations, may also be based information that the member could provide, which would possibly qualify the business for potential opportunities, as described below, with respect to opportunities.

### Industry

The system may also provide the user an assessment of the business' particular industry by drawing from a combination of information resources pertaining to the industry, such as stock market, industry trends, technological advances, academic research and legislative considerations. Information regarding the user's industry sector may be presented to the user, for example through the Reports module. In this instance, graphs, charts and reports can be produced that relate the user's business to others across the selected industry sector for that business.

### Economic Conditions

The system analytics may also be utilized to provide the member a score for the economic conditions that may have importance to the business as an ongoing concern. Based on the demographics of user's business an analysis and score determine economics of, for example, the member's geographic business location, industry trends identified according to NAICS code.

An implementation according to an embodiment of the invention is that a stored procedure executes when, a triggering event, such as a new row is added. According to an algorithm of the stored procedure, parses public data for corresponding businesses within the identified business sector to determine how this company compares with others companies based on the similar relative size, and NAICS sector and produces a score. Algorithm includes comparison of ratios with bank underwriting best practices including but not limited to risk management assessment (RMA) standards.

### Opportunities

According to one aspect of the invention, the user business information is analyzed within the SQL database environment and is then utilized to generate a query to search business opportunities for which the business entity may be well suited. By way of example, the Federal Government posts business opportunities to announce those opportunities for businesses who desire to work with the federal government. These opportunities are posted on the FedBizOpps.gov website. Similar state, local, regional, and private sector opportunities are also provided for search via such web portals.

In the case of FedBizOpps.gov portal, opportunities may be searched by a variety of search criteria, including, among others the NAICS codes. As seen in reference to FIG. 17 a representative flowchart for executing a system query, the SQL Database can execute a stored procedural call 40. responsive to a trigger event, such as those previously described, to retrieve opportunities for which the business is qualified based on the NAICS codes, and other business qualifying variables.

As seen in the following, a representative pseudo code is provided for determining an Opportunities score:
Gather costs and revenue data regarding opportunities completed by user company within a certain timeframe
Gather costs and revenue data regarding opportunities not completed (either bids not won or never bid) by user company within a certain timeframe
Gather revenue and costs data from public and private internet locations for potential opportunities that could have been taken
Calculate potential revenue lost
Calculate percentage of revenue made using actual revenue divided by potential revenue
Determine score based on weighting factors and percentage of revenue earned

Moreover, based on an analysis of the business' information, the procedural call may be tailored to conduct queries for such opportunities may further be limited by such factors as, geographic proximity, number of employees, and demographic information, such as small and minority business preferences, for which the business entity may be qualified. These opportunities may then be presented to the business owner within the presentation layer, for the user to review and assess his or her interest in the particular announcement or request for proposal. If interested, the user, in conjunction with the other elements of the system, such as the Projects module, the may then prepare a plan for bidding on the particular project.

The opportunities that are available for a business' line of work, for example a construction business, are retrieved from a private service on internet that provides these or from websites that are open to the public. These new opportunities are compared to the customer's existing opportunities and a score may be provided for the new and existing opportunities for the member to assess, for example, the profitability of the opportunities. The system may also be tailored to provide recommendations and assistance in qualifying the business to pursue opportunities.

An additional aspect of the system is that it can also provide opportunities for which the business may not currently be qualified, based on the business' available information within the SQL database, and present them to the member as potential opportunities, while providing recommendations for the business owner to become qualified. For example, a business may already be qualified for a potential opportunity, however, based on an item of business information that the member may have overlooked or omitted from the system, (such as staff education, partners experience, financial success/failure, demographics, etc.) the potential opportunity may not otherwise have generated a response as an opportunity for which the business may be qualified.

In another aspect of the invention, the system may also be tailored to provide recommendations and assistance in qualifying the business to pursue opportunities. For example, a qualification report may be prepared through the Reports module. The member's business information may be presented in a format corresponding to a format, required for a vendor to qualify as an approved vendor to a major retail chain, a government contractor for construction projects, and the like. Again, as with the analysis of the user's existing business information, where the information is insufficient to complete a qualification report for a particular entity, the system would prompt the user for the necessary data, thereby adding to the repository of available information, and providing guidance to the member to grow his or her business.

### SME/Case Studies

Because of the capabilities of the system, there is limited need for hiring a Subject Matter Expert (SME) to provide an assessment of the business and provide recommendations to the business owner. This SME capability is by designated function, i.e., opportunity, project, etc. In the instance of academic case studies, based on the user's business information, repositories for academic case studies may reviewed and/or researched for like businesses (size and industry). As with the other elements of the system, the procedure for the analysis of academic case studies is executed via a procedural call, responsive to a trigger event, such as those previously described.

### Legislative Initiatives

As with the other elements of the analytics system, a procedure call, such as that illustrated in FIG. 17 may query repositories for proposed or passed legislation, regulatory rule making by administrative bodies, boards, commissions, and the like, (collectively legislative information), that may be pertinent to the user's particular industry or sector. As with the other elements described, a trigger event will initiate a procedure call to query and review the current legislative issue. As illustrated, the system may “push” the necessary information to the appropriate users, for example via email or message. The importance of the legislation or administrative rulemaking (which may be weighted) may influence whether the overall score of the user's business will be affected by the proposed legislation. As an element of the overall system, analysis of legislative initiatives provides awareness to legislative impacts and industry trends. For example, analysis of assets owned today may be precluded or restricted based on legislative initiatives. Similarly, legislative initiatives are evaluated based industry trends and technological advances and their impact or potential impact on markets of the future.

As with previous elements, information regarding legislative initiatives may be provided in the Reports module. As an additional feature, the system may provide the user draft letters to their legislative representatives at the local, state, and national level or to an administrative rule making authority, expressing their support, opposition or recommendations pertaining to the legislative initiative.

In certain embodiments, the system may allow for the production of an electronic representation of at least one report for a specific business. Other various functions such as, but not limited to, producing an electronic representation of at least one legal business document for the specific business, producing a plurality of statistics for providing project estimates for the specific business, and producing a plurality of future sales prospects for the specific business may be provided through the system.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of a provider serving web pages offering business analytics to a member, the method comprising:
(a) serving, from a server available to the provider, a web page on a member's web browser, wherein the web page presents a plurality of member selectable menu items, the menu items corresponding to a plurality of predetermined categories of business information;
(b) receiving, at the server, a member's selection of a menu item;
(c) automatically with the server computer-generating and transmitting to the web browser a second web page that includes:
(1) information pertaining to the selected category of business information;
(2) a plurality of data entry fields, corresponding to the selected category of business information, wherein each data entry field, corresponds to a data element;
(3) a link, responsive to a member selection in the web browser;
(d) receiving, in response to a member's selection of the link, data elements entered into the data entry field by the user;
(e) storing, in a database available to the provider, the received data elements;
(f) analyzing, the database data elements; and
(g) providing an actionable recommendation to the member based on the analysis of the data elements.

2. The method of claim 1, wherein, the data entry fields are populated by data elements previously stored in the database, and wherein the data elements are associated with a member's ID.

3. The method of claim 1, wherein the actionable recommendation includes; a business opportunity, determined by a query, performed automatically by the server, wherein the query searches a web portal announcing business opportunities based on one or more qualification factors corresponding to said data elements.

4. The method of claim 3, wherein the server provides a report to the member, via the member's web browser, wherein the report comprises an application for the business opportunity.

5. A computer-readable memory adapted for use by a provider in serving web pages offering business analytics to its members, the computer-readable memory is used to direct a computer available to the provider to perform the steps of:
(a) serving, from a server available to the provider, a web page on a member's web browser, wherein the web page presents a plurality of member selectable menu items, the menu items corresponding to a plurality of predetermined categories of business information;
(b) receiving, at the server, a member's selection of a menu item;
(c) automatically with the server computer-generating and transmitting to the web browser a second web page that includes:
(1) information pertaining to the selected category of business information;
(2) a plurality of data entry fields, corresponding to the selected category of business information, wherein each data entry field, corresponds to a data element;
(3) a link, responsive to a member selection in the web browser;
(d) receiving, in response to a member's selection of the link, data elements entered into the data entry field by the user;
(e) storing, in a database available to the provider, the received data elements;
(f) analyzing, the database data elements; and
(g) providing an actionable recommendation to the member based on the analysis of the data elements.

6. The computer readable storage media of claim 5, wherein, the data entry fields are populated by data elements previously stored in the database, and wherein the data elements are associated with a member's ID.

7. The computer readable storage media of claim 5, wherein the actionable recommendation includes; a business opportunity, determined by a query, performed automatically by the server, wherein the query searches a web portal announcing business opportunities based on one or more qualification factors corresponding to said data elements.

8. The computer readable storage media of claim 5, wherein the actionable recommendation includes; a legislative initiative, determined by a query, performed automatically by the server, wherein the query searches a web portal hosting legislative initiatives based on one or more data elements.

9. The computer readable storage media of claim 8, wherein the server automatically provides a report to the member, wherein the report includes correspondence, addressed to a member's legislative representative.

10. A system useful in a provider serving web pages offering business analytics, the system comprising:
(a) a computer storage containing data, for each of a plurality of web pages;
(b) a computer server available to the provider, which is coupled to the computer storage and programmed to:
(1) serve, from a server available to the provider, a web page on a member's web browser, wherein the web page presents a plurality of member selectable menu items, the menu items corresponding to a plurality of predetermined categories of business information;
(2) receive, at the server, a member's selection of a menu item;
(3) automatically with the server computer-generating and transmitting to the web browser a second web page that includes:
(i) information pertaining to the selected category of business information;
(ii) a plurality of data entry fields, corresponding to the selected category of business information, wherein each data entry field, corresponds to a data element;
(iii) a link, responsive to a member selection in the web browser;
(4) receiving, in response to a member's selection of the link, data elements entered into the data entry field by the user;
(5) storing, in a database available to the provider, the received data elements;
(6) analyzing, the database data elements; and
(7) providing an actionable recommendation to the member based on the analysis of the data elements.
